(19) United States
(12) Patent Application Publication
(10) Pub. No.: US 2022/0128386 A1
(43) Pub. Date: Apr. 28, 2022

(54) THREE-PLY DRUM SHELL WITH AERATED CORE

(71) Applicant: Hyuk Jae PARK, Port Coquitlam (CA)

(72) Inventor: Hyuk Jae PARK, Port Coquitlam (CA)

(21) Appl. No.: 17/081,770

(22) Filed: Oct. 27, 2020

(51) Int. Cl. G01D 13/02; G01D 13/22

(52) U.S. Cl. CPC G01D 13/02; G01D 13/22

(57) ABSTRACT

A drum shell for enhancing the sound and tone qualities of a drum is provided. The drum shell has an outer band, an inner band, and an aerated core interposed therebetween. In one aspect, the core defines a plurality of spaces each providing a sound tube for vibrating air contained within the spaces.

### TECHNICAL FIELD

The present invention relates to musical instruments. More particularly, the present invention relates to a shell for a drum or other percussion instruments and a method for making same.

### BACKGROUND

The drum is one of the key percussion instruments played today. The shell of a drum has a significant impact on the volume and tone qualities of the drum. Typically, the shell is made by laminating multiple plies, usually thin sheets of wood and/or other material, into an annular ring. The composition and physical properties of the shell contribute to the acoustic characteristics of the drum. For example, the sound qualities of a wooden drum shell can be characterized as warm and smooth. The sound qualities of a metal drum shell can be characterized as clear, bright and loud. Additionally, a thin laminated shell usually gives a darker tone with a lower pitch and in contrast, a thicker laminated shell tends to give a brighter tone with a higher pitch.

There is a general desire for a drum shell for amplifying the sound volume and optimizing the tone qualities of a drum. There is also a general desire for an improved shell for a drum or other percussion instruments for enhancing the resonance and dynamic range of the instrument.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a drum shell having an outer layer, an inner layer, and an aerated core layer therebetween. In some aspects, the aerated core layer is provided by a central core having a plurality of spaced apart spacers defining spaces therebetween. In some aspects, the spacers extend generally parallel to one another and the spaces extend generally parallel to one another. In some aspects, the spacers extend generally vertically along a height of the drum shell and the spaces extend generally vertically along a height of the drum shell. In some aspects, the drum shell is incorporated into a drum, for example, a snare drum.

One aspect provides a method of making a drum shell. A first piece of rectangular wood is rolled into a generally cylindrical inner band. A second piece of rectangular wood is rolled and positioned around the inner band to form a core. The second piece of rectangular wood has a planar surface and a ridged surface, and the ridged surface defines a plurality of spaced-apart spaces. A third piece of rectangular wood is rolled and positioned around the core to form an outer band. The drum shell can be formed in any suitable manner, for example by airbag molding.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows schematically a perspective view of an example embodiment of a drum shell of the present invention, illustrating its vertical axis.

FIG. 2 schematically shows an inner band, an outer band, and a core of the drum shell of FIG. 1.

FIG. 3 shows a partial perspective view of the drum shell of FIG. 2

FIG. 4 shows an exploded view of a snare drum having the drum shell of FIG. 2.

FIG. 5 shows a side view of the snare drum of FIG. 4.

FIG. 6 shows a top view of the snare drum of FIG. 4.

FIG. 7 shows a bottom view of the snare drum of FIG. 4.

FIG. 8 shows an enlarged partial view of an example embodiment of a bearing edge for a drum.

### DESCRIPTION

The inventor has developed an improved drum shell for enhancing the sound volume and optimizing the tone qualities of a drum. The drum shell has an outer band, an inner band, and an aerated core interposed therebetween. In some embodiments, the aerated core defines a plurality of spaces each providing a sound tube for vibrating air contained within the spaces. These spaces can modify the resonance of a drum and enhance the drum's dynamic range.

As used herein, the term “inwardly” means a direction towards the axial centreline of a drum shell/drum. The term “outwardly” means the opposite of inwardly, i.e. a direction away from the axial centreline of a drum shell/drum.

As used herein, the term “vertical” means a direction between the two opposing ends of a drum shell, the two opposing ends configured to receive the drum heads. The vertical direction is also parallel to the axial centreline of a drum shell/drum. The “height” of a component is described herein with reference to its dimensions in the vertical direction.

As used herein, the term “substantially” means plus or minus 5%.

The following description describes:
an embodiment of a drum shell 100 according to the present invention;
a method for making drum shell 100; and
a drum having drum shell 100.

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

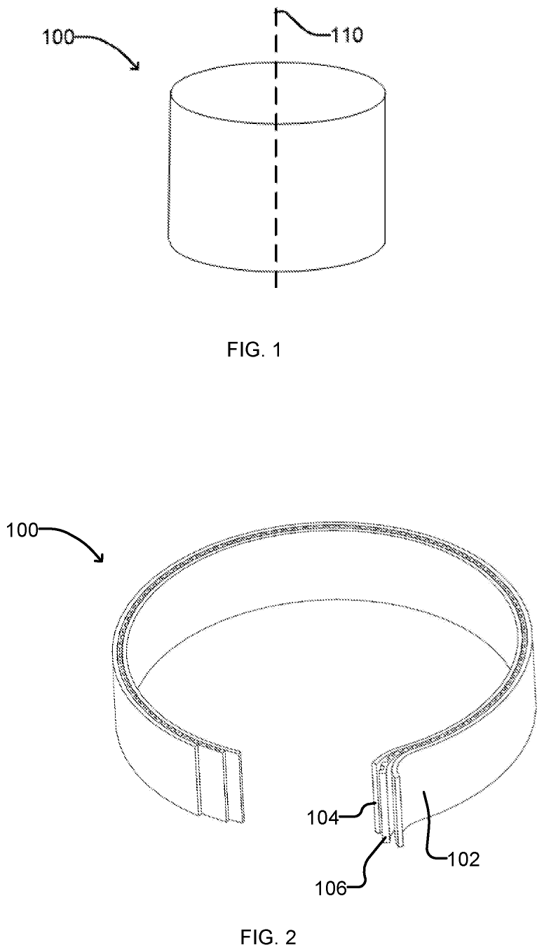

With reference to FIGS. 1 to 3, an example embodiment of a drum shell 100 is illustrated. FIG. 1 is a schematic perspective view of drum shell 100 showing that drum shell 100 is hollow and cylindrical in shape and has a vertically extending axial centreline 110.

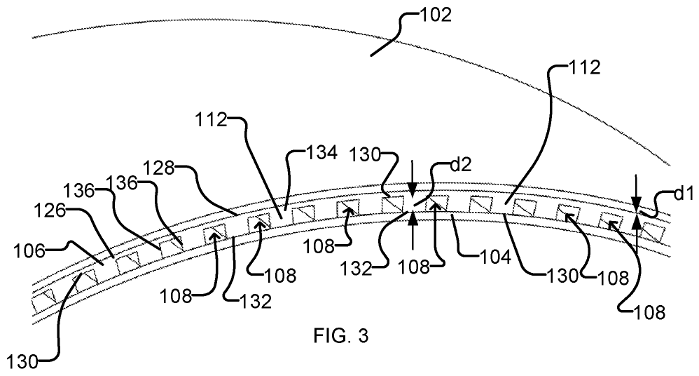

FIG. 2 schematically shows that drum shell 100 has three layers: an outer band 102, an inner band 104, and a core 106 interposing the outer and inner band. FIG. 3 shows a partially enlarged view of drum shell 100 illustrating its aerated structural construction.

Drum shell 100 has inner band 104, core 106 surrounding inner band 104, and outer band 102 surrounding core 106. These three layers, i.e. inner band 104, core 106, and outer band 102 are in direct contact with each other, with outer band 102 wrapping around core 106 and core 106 wrapping around inner band 104. In alternative embodiments, drum shell 100 could be provided with additional layers, as long as aerated core 106 is present.

In some embodiments, inner band 104, core 106, and outer band 102 are made of wood, such as maple, birch, mahogany, walnut, oak, beech, cherry, bubinga, poplar, ash, or the like, or a combination thereof. In some embodiments, inner band 104, core 106, and outer band 102 are made of the same type of wood. In other embodiments, inner band 104, core 106, and outer band 102 are independently made of different types of wood. Any suitable wood construction can be used to provide each of inner band 104, core 106 and outer band 102, e.g. a solid wood structure, or a plywood structure made from any desired number of layers of plywood, e.g. 2 ply, 3 ply, 4 ply, 5 ply, 6 ply, 7 ply, 8 ply, 9 ply, 10 ply, 11 ply, 12 ply or more. In other embodiments, at least one of inner band 104, core 106, and outer band 102, any combination of these layers or all of them, is made of a non-wood material, including metal, plastic, or fiberglass.

In the illustrated embodiment, inner band 104, outer band 102, and core 106 are aligned with each other so that they are fully overlapped and in contact along their vertical height. Inner band 104, outer band 102, and core 106 each have two vertically opposed open ends: an upper end 114, 116, 118 and a lower end 120, 122, 124. Upper ends 114, 116, 118 are aligned and lower ends 120, 122, 124 are aligned. In the illustrated embodiment, inner band 104, outer band 102, and core 106 have the same height and each form bearing edges of a drum. The bearing edge is the portion of drum shell 100 that contacts the drumheads of a drum. In alternative embodiments, the bearing edge could be formed on any desired portion of the drum shell.

In some other embodiments, not all three layers form bearing edges of a drum. For example, the edges of inner band 104, outer band 102, and core 106 may not be aligned to form a bearing edge. Inner band 104, outer band 102, and core 106 may have different heights. In some embodiments, inner band 104 does not form a bearing edge and instead only outer band 102 and core 106 form bearing edges of a drum. This could be provided by an arrangement where outer band 102 and core 106 have the same height and inner band 104 has a shorter height and is therefore positioned so that its upper end 114 is positioned ata lower vertical elevation than upper ends 116, 118 of core 106. In alternative embodiments, the bearing edge could be formed by outer band 102 and a portion of core 106.

Alternatively, the upper ends 114A, 116A and 118A could taper downwardly and inwardly towards the interior of the drum shell 100, so that the surface formed by all of ends 114A, 116A and 118A is angled, as illustrated in one example in FIG. 8 showing this exemplary embodiment of outer band 102A, inner band 104A and aerated core layer 106A in partial cross-sectional view. In some embodiments, only upper end 118 of outer band 102 and a portion of upper end 116 of core 106 form the bearing edge of drum shell 100. Other configurations that provide other combinations of one or two of the ends of bands 102, 104 and core 106 providing the bearing edge of the drum can be devised.

In various embodiments, drum shell 100 can be provided with any type of bearing edges known in the art, e.g. 45-degree, 45-degree with countercut, 45-degree roundover, dual 45-degree, 30-degree, roundover, extreme roundover, hybrid, or the like.

Inner band 104 and outer band 102 are hollow and cylindrical in shape. Each one of inner band 104 and outer band 102 defines a continuous and solid ring. Without being bound by theory, the continuous ring arrangement provides uniform vibration characteristics of inner band 104 and outer band 102 along their respective circumferences. Inner band 104 and outer band 102 can be provided in any desired thickness. In one non-limiting embodiment, inner band 104 has a thickness of 1, 2 or 3 mm, and outer band 102 independently has a thickness of 1, 2 or 3 mm. The thicknesses of inner band 104 and outer band 102 can be the same or can be different.

Core 106 is an example of an aerated core. Core 106 provides a plurality of spaces 108 defined between spacers 112. Spacers 112 may be a plurality of staves spaced from one another and dimensioned to create the spaces 108. Each space 108 provides a sound tube for vibrating air contained within the spaces. Without being bound by theory, spaces 108 modify the resonance of a drum comprising drum shell 100 and enhance the drum's dynamic range. In the illustrated embodiment, spacers 112, and thus spaces 108, extend in the vertical direction.

Core 106 has a void fraction of about 25% to about 35% (i.e. a fraction of empty space defined by spaces 108 is about 25% to about 35% relative to the total volume occupied by core 106). The fraction of volume of spaces 108 over the total volume of core 106 may be in the range of about 25% to about 35% or less, including any value or subrange therebetween, e.g. 26, 27, 28, 29, 30, 31, 32, 33, or 34% less.

Core 106 connects inner band 104 with outer band 102. The combination of inner band 104, core 106, and outer band 102 provides the physical integrity of drum shell 100.

In the illustrated embodiment, spacers 112 and therefore spaces 108 each extend in a vertical direction that is substantially parallel to the axial centreline 110 of drum shell 100. In other embodiments, spaces 108 are oriented in a non-vertical direction. For example, in some embodiments, spacers 112 and therefore spaces 108 are oriented at an angle of between about 5° and about 85°, including any subrange therebetween, e.g. 5, 10, 15, 20, 25, 30, 35, 40, 45, 50, 55, 60, 65, 70, 75, 80 or 85° relative to the central vertical axis of drum shell 100. In some embodiments, spacers 112 extend from upper end 116 to lower end 122 of core 106.

In the illustrated embodiment, spacers 112 are a plurality of staves vertically spaced from one another and dimensioned to create spaces 108. Spacers 112 and spaces 108 extend fully from upper end 116 to lower end 122 of core 106. In other embodiments, spacers 112 and therefore spaces 108 do not extend the entire height of core 106. For example, in alternative embodiments, spaces 108 might extend along only 60%, only 70%, only 80%, only 90% or only 95% of the vertical height of core 106. In some embodiments, spacers 112 are provided by staves.

Core 106 is hollow and cylindrical in its overall shape. A cross-section taken through core 106 perpendicular to its vertical axis defines a substantially circular ring. In the illustrated embodiment, core 106 has an annular portion 126 and a plurality of spacers 112 formed or provided on an inner surface 130 of annular portion 126. Core 106 may be integrally formed as one piece (e.g. by carving spaces 108 with a wood router to form spacers 112) or may be assembled wherein spacers 112 are attached (e.g. glued, stapled, nailed, held in place in any other suitable manner) onto annular portion 126. In some embodiments, rather than being fixed to annular portion 126, spacers 112 are held in position by being sandwiched against inner band 104 and are held in place by friction. Although in the illustrated embodiment annular portion 126 has been illustrated as being disposed exteriorly of spacers 112, in alternative embodiments, annular portion 126 could be disposed radially interiorly of spacers 112, in which case spacers 112 would be provided on or associated with an outer surface 128 of the annular portion 126.

In the illustrated embodiment, annular portion 126 defines two opposed continuous and planar surfaces: an inner surface 130 and an outer surface 128. Inner surface 130 is in direct contact with spacers 112. Outer surface 128 is in direct contact with the inner surface of outer band 102. In example embodiments, annular portion 126 has a thickness, d1, between inner surface 130 and outer surface 128, of about 1 mm to about 2 mm (including any value or subrange therebetween, e.g. 1.1 mm, 1.2 mm, 1.3 mm, 1.4 mm, 1.5 mm, 1.6 mm, 1.7 mm, 1.8 mm or 1.9 mm).

Spacers 112 are secured on to inner surface 130 of annular portion 126 in a parallel and spaced-apart manner. Spacers 112 each have a base surface 134 and a tip surface 132. Base surfaces 134 are in direct contact with or integrally formed with inner surface 130 of annular portion 126. Tip surfaces 132 are in direct contact with the outer surface of inner band 104. Spacers 112 extend radially and inwardly from inner surface 130 to tip surface 132 by a distance d2. In some embodiments, the extent d2 that spacers 112 extend radially and inwardly is about 1 mm to about 2 mm (including any value or subrange therebetween, e.g. 1.1 mm, 1.2 mm, 1.3 mm, 1.4 mm, 1.5 mm, 1.6 mm, 1.7 mm and 1.8 mm). Spacers 112 also extend vertically from upper end 116 and lower end 122 of core 106. In the illustrated embodiment, spacers 112 have a rectangular cross section although other shapes may be suitable. In some embodiments, spacers 112 have a square cross-section.

In the illustrated embodiment, spacers 112 are evenly spaced apart from each other to form vertical spaces 108 between adjacent spacers 112. The dimensions of spacers 112 and their spacing (and correspondingly the dimensions of spaces 108), can be varied in alternative embodiments, and are preferably but not necessarily kept approximately the same for each one of spaces 108 and spacers 112. In one example embodiment, spacers 112 have a width of approximately 3 mm and spacers 112 are spaced apart by approximately 3 mm. In alternative embodiments, the spacing between spacers 112 could be increased so that spaces 108 are wider. In alternative embodiments, the width of spacers 112 could be increased, to decrease the number of spacers 112 present on core 106. Factors to consider in determining how many spacers 112 should be provided include ensuring that core 106 can be formed into its final cylindrical shape, as well as ensuring a sufficient degree of physical contact between inner band 104 and outer band 102 and also a sufficient degree of physical strength for drum shell 100 as a whole (e.g. if core 106 is too airy, drum shell 100 may not be sufficiently strong).

In the illustrated embodiment, spacers 112 are disposed substantially symmetrically around the circumference of core 106. In alternative embodiments, spacers 112 could be disposed asymmetrically around the circumference of core 106, which would result in the provision of a plurality of spaces 108 having different dimensions. The number of spacers 112 that core 106 may have varies and may depend on certain factors such as the width of spacers 112 and the width of spaces 108.

In the illustrated embodiment, spaces 108 extend in a vertical direction that is substantially parallel to the axial centreline 110 of drum shell 100. Spaces 108 extend from upper end 116 and lower end 122 of core 106. In one example embodiment, spaces 108 have a width of 3 mm and the extent to which spaces 108 extend radially inwardly is about 3 mm. In the illustrated embodiment, spaces 108 have a rectangular cross-section although this may change depending on the shape of spacers 112.

In some embodiments, annular portion 126 is omitted. Instead, spacers 112 are arranged to form core 106 and are sandwiched directly between outer band 102 and inner band 104, where base surfaces 134 are in direct contact with outer band 102 and tip surfaces 132 are in direct contact with inner band 104. Such an arrangement could be accomplished, for example, by securing individual strips of material in place in any appropriate manner to provide spacers 112 and spaces 108.

In some embodiments, by virtue of the presence of spaces 108 created by spacers 112, drum shell 100 has a mass that is in the range of about 25% to about 35% less (including any value or subrange therebetween, e.g. 26, 27, 28, 29, 30, 31, 32, 33, or 34% less) than an equivalent drum shell (of the same dimensions and made of the same material) that does not include any spaces. In some embodiments, spaces 108 created by spacers 112 yield a drum shell 100 that has a mass that is about 30% less than an equivalent drum shell (of the same dimensions and made of the same material) that does not include any spaces. In some embodiments, this reduction in the mass of drum shell 100 yields a drum that has enhanced tonal properties as compared with a drum shell that does not include any spaces 108, has a higher dynamic range as compared with a drum shell that does not include any spaces 108, and/or yields a higher volume when struck as compared with a drum shell that does not include any spaces 108.

Any suitable method of manufacture may be used to make drum shell 100. Inner band 104, core 106, and outer band 102 may optionally be bonded layer-to-layer in in any suitable manner, for example by using a press or friction fit, or by using suitable adhesives or fasteners such as screws, staples or bolts. In some embodiments, inner band 104, core 106 and outer band 102 are held together via the external structure of a drum, e.g. drum 200 as described below, and are not themselves secured together in any manner prior to the assembly of the drum.

One example method for constructing drum shell 100 starts by rolling a first sheet of rectangular wood to form inner band 104. Suitable processes for heating and rolling wood to form such circular shapes are known to those skilled in the art. A second piece of rectangular wood is carved with a router to provide a series of linearly spaced apart spaces 108 defined between spacers 112 and is then wrapped around inner band 104 in like manner, thereby forming core 106. A third sheet of rectangular wood is wrapped around core 106 in like manner, thereby forming outer band 102. The assembled drum shell 100 is placed in a suitable mold (e.g. an airbag mold) and cured to achieve the final finished drum shell 100.

Another example method for constructing drum shell 100 starts by rolling a first piece of rectangular wood into inner band 104. Outer band 102 is rolled from a second piece of rectangular wood. Inner band 104 is placed axially concentrically within outer band 102. Pieces of wood of suitable dimensions to provide spacers 112 are inserted between outer band 102 and inner band 104 to create a tight fit between spacers 112 and the bands, leaving spaces 108 defined between each adjacent pair of spacers 112.

Another example method for constructing drum shell 100 starts by wrapping inner band 104 with core 106. Core 106 is then wrapped with outer band 102.

Another example method for constructing drum shell 100 start by inserting inner band 104 axially and concentrically into core 106 and then inserting core 106 axially and concentrically into outer band 102. Any suitable method of assembling the components of drum shell 100 can be used in alternative embodiments.

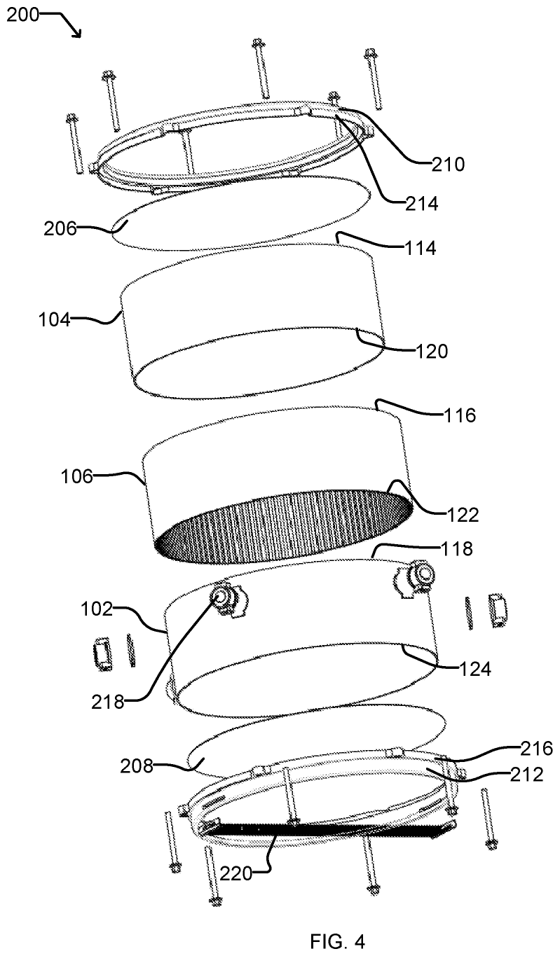

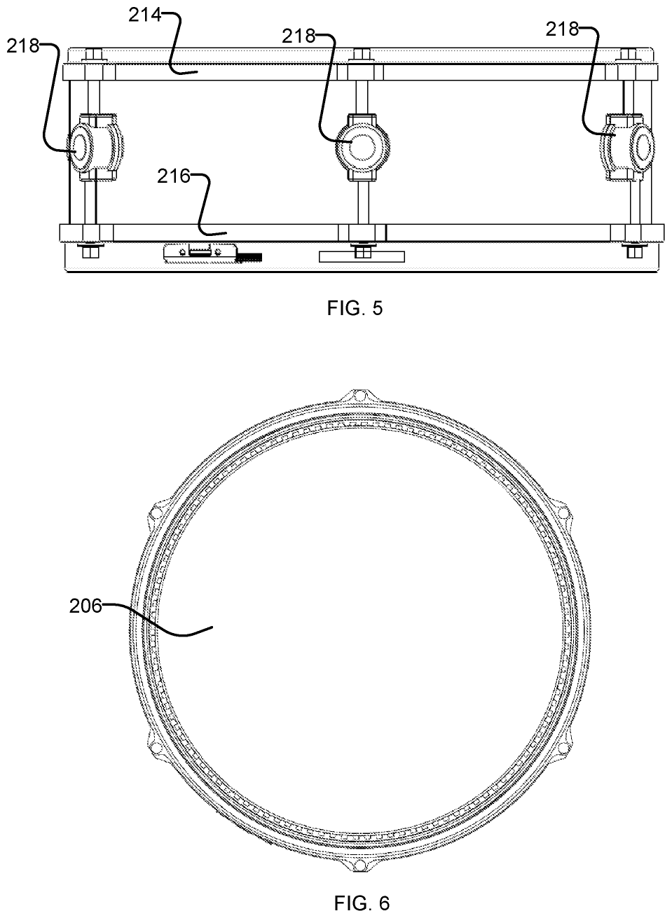

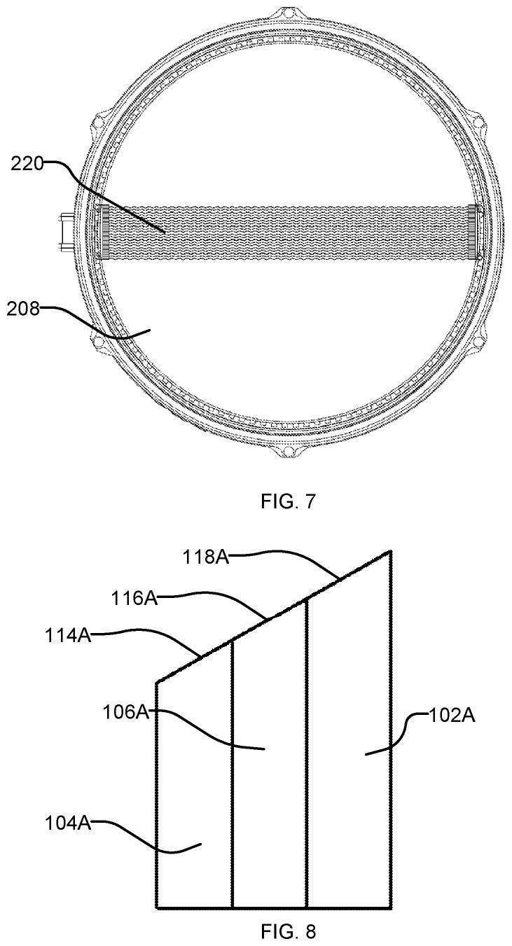

With reference to FIGS. 4 to 7, an example embodiment of a snare drum 200 incorporating drum shell 100 is illustrated. FIG. 4 is an exploded view of snare drum 200 showing the exploded parts of drum shell 100, i.e. inner band 104, core 106, and outer band 102. FIG. 5 is a side view of snare drum 200 in its assembled configuration. FIG. 6 is a top view of snare drum 200, showing its batter head 206. FIG. 7 is a bottom view of snare drum 200, showing its snare head 208.

While an exemplary embodiment is described with reference to snare drum 200, it will be understood by those skilled in the art that other percussion instruments, including other types of drums, could be modified in a similar manner to produce desired changes in tone. For example, in alternative embodiments, the drum could be a tom-tom, a bass drum, a marching drum, or the like.

Snare drum 200 has drum shell 100. Over opposed ends 114, 116, 118 and 120, 122, 124, drumheads are stretched, to provide batter head 206 and snare head 208, respectively. Batter head 206 and snare head 208 may be made from any suitable material, for example, natural leather or plastic. When batter head 206 and snare head 208 are secured in position, the bearing edges of the drum shell, in the illustrated embodiment being the bearing edges formed by opposed ends 114, 116, 118 and 120, 122, 124, are in direct contact with batter head 206 and snare head 208, respectively.

When snare drum 200 is played, a user will strike the batter head 206 with an appropriate implement, e.g. a drumstick or wire brush. The striking of batter head 206 causes vibration of batter head 206 and drum shell 100. Energy is transferred from batter head 206 to the bearing edge formed by upper ends 114, 116, 118 and then to drum shell 100. Because drum shell 100 has an aerated core and thus has a mass that is less than the mass a corresponding solid drum shell would have, the resonance and tone of the sound created by the vibration of drum shell 100 is enhanced as compared with that of a corresponding solid drum shell.

Snare drum 200 can be assembled to incorporate drum shell 100 in any suitable manner. For example, in the illustrated embodiment, to secure batter head 206 and snare head 208 in position across upper ends 114, 116, 118 and 120, 122, 124, first and second hoops 210, 212 are provided and secured to the outer perimeter of batter head 206 and snare head 208, respectively, or are otherwise used to secure batter head 206 and snare head 208 in place against drum shell 100. First and second clamp frames 214, 216 are engaged around the outer periphery of each one of first and second hoops 210, 212 respectively to secure hoops 210, 212 and batter and snare heads 206, 208 in position. Tensioning brackets 218 are secured at uniform intervals on the exterior side of drum shell 100 and can be used to adjust the tension of batter head 206 and snare head 208. Snares 220 are stretched across snare head 208. Clamp frames 214, 216 encircle the outer edges of drum shell 100.

When batter head 206 is struck by a drumstick, batter head 206 vibrates and air inside snare drum 200 is compressed. Without being bound by theory, vibrations from batter head 206 are believed to be transmitted to drum shell 100 via the bearing edges formed by opposed ends 114, 116, 118, 120, 122, 124 and cause outer band 102, core 106, and inner band 104 to vibrate, i.e. to excite all three layers of drum shell 100. The compressed air inside inner band 104 exerts an outward pressure on inner band 104 and snare head 208 and then is reflected back by inner band 104 and snare head 208.

Without being bound by theory, the provision of spaces 108 defined by spacers 112 allows for modification of the tonal properties of drum 200. Spaces 108 each provide a sound tube. The compressed air vibrates within each one of spaces 108, exerting pressure and being reflected by side surfaces 136 of spacers 112, as well as the outer surface of inner band 104 and the inner surface 130 of annular portion 126. Drum shell 100 is further excited by the vibration and reverberation of the compressed air within spaces 108.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

Without limitation, various aspects include the following:
A. A drum shell comprising:

an outer band;

an inner band; and

an aerated core layer between the outer band and the inner band.
B. A drum shell as defined in aspect A, wherein the aerated core layer has a void fraction of about 25% to about 35%, thereby providing a drum shell having a mass that is about 25% to about 35% lower than a mass that the drum shell would have if made from equivalent solid material.
C. A drum shell as defined in either one of aspects A or B or any other aspect herein, wherein the aerated core layer comprises a plurality of spaced-apart spacers, with a plurality of spaces being defined between adjacent pairs of the spacers.
D. A drum shell as defined in aspect C or any other aspect herein, wherein the spaces each extend in a direction that is parallel to a central axis of the drum shell.
E. A drum shell as defined in claim C or any other aspect herein, wherein the spaces each extend at an angle of between about 5° and about 85° relative to a central vertical axis of the drum shell.
F. A drum shell as defined in any one of aspects C to E or any other aspect herein, wherein the spaces are evenly spaced apart.
G. A drum shell as defined in any one of aspects C to F or any other aspects herein, wherein the spacers comprise a plurality of staves extending vertically and horizontally spaced from one another and dimensioned to create the spaces.
H. A drum shell as defined in aspect G or any other aspect herein, the core comprising:
   an annular portion having an inner surface, wherein the plurality of staves are secured to the annular portion.
I. A drum shell as defined in aspect H, wherein the plurality of staves are secured to an inner surface of the annular portion.
J. A drum shell as defined in aspect I or any other aspect herein, the staves each extending radially and inwardly from the inner surface of the annular portion.
K. A drum shell as defined in any one of aspects H to J or any other aspect herein, the annular portion having first and second opposed ends; and the staves each extending vertically from the first end to the second end.
L. A drum shell as defined in any one of aspects H to K or any other aspect herein, the staves each having a rectangular cross-section.
M. A drum shell as defined in any one of aspects H to K or any other aspect herein, the staves each having a square cross-section.
N. A drum shell as defined in any one of the aspects herein, the inner band, the core, and the outer band having the same vertical height.
O. A drum shell as defined in any one of the aspects herein, the inner band, the core, and the outer band being fully overlapped with each other.
P. A drum shell as defined in any one of the claims herein, the inner band, the core, and the outer band forming bearing edges of a drum.
Q. A drum shell as defined in any one of the aspects A to P or any other aspect herein, the outer band and a portion of the core forming bearing edges of a drum.
R. A drum shell as defined in any one of the aspects herein, the inner band, the core, and the outer band being in direct contact with each other.
S. A method for making a drum shell, the method comprising:
   rolling a first piece of rectangular wood into a generally cylindrical inner band;
   rolling a second piece of rectangular wood and positioning the second piece of rectangular wood around the inner band to form a core, the second piece of rectangular wood having a planar surface and a ridged surface, wherein the ridged surface defines a plurality of parallel spaced-apart spaces; and
   rolling a third piece of rectangular wood onto the core to form an outer band.
T. A method as defined in the preceding aspect, wherein the second piece of rectangular wood is rolled so that the ridged surface is in contact with the generally cylindrical inner band.
U. A drum comprising a drum shell as defined in any one of the aspects herein.
V. A drum as defined in aspect U, wherein the drum is a snare drum.
W. A drum shell comprising:
   an outer band;
   an inner band; and
   a middle band
      wherein each one of the outer, inner and middle bands independently has a thickness in the range of about 1 mm to about 3 mm.

1. A drum shell comprising:
an outer band;
an inner band; and
an aerated core layer between the outer band and the inner band.

2. A drum shell as defined in claim 1, wherein the aerated core layer has a void fraction of about 25% to about 35%.

3. A drum shell as defined in claim 1, wherein the aerated core layer comprises a plurality of spaced-apart spacers, with a plurality of spaces being defined between adjacent ones of the plurality of spacers.

4. A drum shell as defined in claim 3, wherein the spaces each extend in a direction that is parallel to a central axis of the drum shell.

5. A drum shell as defined in claim 3, wherein the spaces each extend at an angle of between about 5° and about 85° relative to a central vertical axis of the drum shell.

6. A drum shell as defined in claim 3, wherein the plurality of spaces are evenly spaced apart.

7. A drum shell as defined in claim 3, wherein the plurality of spaced-apart spacers comprise a plurality of staves extending vertically, the plurality of staves being horizontally spaced from one another and dimensioned to create the spaces.

8. A drum shell as defined in claim 7, the aerated core layer comprising:
an annular portion, wherein the plurality of staves are secured to the annular portion.

9. A drum shell as defined in claim 8, wherein the plurality of staves are secured to an inner surface of the annular portion.

10. A drum shell as defined in claim 9, the staves each extending radially and inwardly from the inner surface of the annular portion.

11. A drum shell as defined in claim 8, wherein:
the annular portion having first and second opposed vertical ends; and
the staves each extending vertically from the first vertical end to the second vertical end.

12. A drum shell as defined in claim 7, each one of the plurality of staves having a rectangular cross-section.

13. A drum shell as defined in claim 7, each one of the plurality of staves having a square cross-section.

14. A drum shell as defined in claim 1, the inner band, the aerated core layer, and the outer band having the same vertical height and being fully overlapped.

15. A drum shell as defined in claim 1, the inner band, the aerated core layer, and the outer band forming bearing edges of a drum.

16. A drum shell as defined in claim 1, the outer band and a portion of the aerated core layer forming bearing edges of a drum.

17. A drum shell as defined in claim 14, the inner band, the aerated core layer, and the outer band being in direct contact with each other.

18. A method for making a drum shell, the method comprising:
rolling a first piece of rectangular wood into a generally cylindrical inner band;
rolling a second piece of rectangular wood and positioning the second piece of rectangular wood around the generally cylindrical inner band to form a core, the second piece of rectangular wood having a planar surface and a ridged surface, wherein the ridged surface defines a plurality of parallel spaced-apart spaces; and
rolling a third piece of rectangular wood onto the core to form an outer band.

19. A drum comprising a drum shell as defined in claim 1, wherein the drum is optionally a snare drum.

20. A method of playing a drum, the method comprising:
striking a batter head of a drum as defined in claim 19;
allowing vibrations from the batter head to be transmitted to the drum shell via bearing edges of the drum shell; and
allowing air to vibrate within spaces defined in the aerated core layer.
